(19) United States
(12) Patent Application Publication
(10) Pub. No.: US 2018/0052058 A1
(43) Pub. Date: Feb. 22, 2018

(54) NON-CONTACT TEMPERATURE SENSING APPARATUS

(71) Applicant: LATTRON CO., LTD., Daejeon (KR)

(72) Inventors: WonKyoung LEE, Daejeon (KR); ChungKook LEE, Daejeon (KR)

(73) Assignee: LATTRON CO., LTD., Daejeon (KR)

(21) Appl. No.: 15/674,897

(22) Filed: Aug. 11, 2017

(30) Foreign Application Priority Data
Aug. 16, 2016 (KR) 10-2016-0103810

(51) Int. Cl. G01J 5/22; G01J 5/00; G01J 5/04; G01J 5/06

(52) U.S. Cl. CPC G01J 5/22; G01J 5/0007; G01J 2005/068; G01J 5/06; G01J 5/042

(57) ABSTRACT

Disclosed is a non-contact temperature sensing apparatus. The non-contact temperature sensing apparatus includes a substrate connected to one end portion of a lead frame; the lead frame extended to an upper portion of the substrate; an element for sensing temperature attached to the other end portion of the lead frame; and an element for compensating temperature attached to a lower surface of the substrate, wherein the element for sensing temperature is separated from the substrate, thereby increasing a thermal responsibility.

### BACKGROUND OF THE INVENTION

### 1. Field of the Invention

The present invention relates to a non-contact temperature sensing apparatus and, more specifically, relates to a non-contact temperature sensing apparatus in that an element for sensing temperature is attached to an upper portion of a PCB and the element for sensing temperature is separated from the PCB, thereby improving thermal responsibility and reaction rate thereof.

### 2. Description of Related Art

In the printing devices of applying an electro photographic system, such as a copy machine, a printer, and a facsimile machine etc., a toner is melted on a paper to be fixed by using a thermal fixing machine. At this time, a detecting element such as a thermistor serves to detect the surface temperature of a heat roller of a drum so as to stabilize the fixing condition of the thermal fixing machine.

In the Japanese Publication Patent 2010-043930, the surface temperature of the heat roller of the drum is detected through a detecting element module, in that a thin film type thermistor is mounted on single circuit board including a FPCB (Flexible PCB).

However, in the conventional art, a thin film type thermistor material is applied to an alumina substrate and separate electrodes for electrically connecting to outside are required. Also, a separate protective layer for protecting the entire elements is required. Accordingly, there are problems in that the manufacturing cost and time are increased.

### SUMMARY OF THE INVENTION

The present invention has been made in an effort to solve the problems of the conceptual description of the conventional art as described above, and the objective of the present invention is to provide a non-contact temperature sensing apparatus in that an element for sensing temperature is attached to an upper portion of a PCB and the element for sensing temperature is separated from the PCB, thereby improving thermal responsibility and reaction rate thereof.

According to an aspect of the invention to achieve the object described above, there is provided a non-contact temperature sensing apparatus including: a substrate having wiring circuits and connected to one end portion of a lead frame; the lead frame extended to an upper portion of the substrate; an element for sensing temperature attached to the other end portion of the lead frame; an element for compensating temperature attached to a lower surface of the substrate; and a case for housing the substrate, the element for sensing temperature, and the element for compensating temperature and accommodating a radiant heat flowed therein, wherein the element for sensing temperature is separated from the substrate, thereby increasing a thermal responsibility.

Also, the non-contact temperature sensing apparatus further includes a body tube portion formed on the upper portion of the case and providing an inflow path of the radiant heat and a tuning portion formed at the body tube portion and tuned through tightening and loosening in the manner of a screw or a sliding so as to control an inflow value of the radiant heat flowed into the element for sensing temperature.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating a non-contact temperature sensing apparatus according to one embodiment of the present invention;

FIG. 2 is a planar view illustrating the non-contact temperature sensing apparatus of FIG. 1;

FIG. 3 is a sectional view illustrating a non-contact temperature sensing apparatus according to another embodiment of the present invention;

FIG. 4 is a planar view illustrating the non-contact temperature sensing apparatus of FIG. 3;

FIG. 5 is a graph illustrating a thermal response characteristic of a non-contact temperature sensing apparatus according to one embodiment of the present invention; and

FIG. 6 is a graph illustrating a thermal response characteristic of the conventional thermistor elements of a thin film type.

### DETAILED DESCRIPTION OF THE PREFERRED EMBODIMENTS

Hereinafter, preferred embodiments of the invention will be described in more detail with reference to the accompanying drawings.

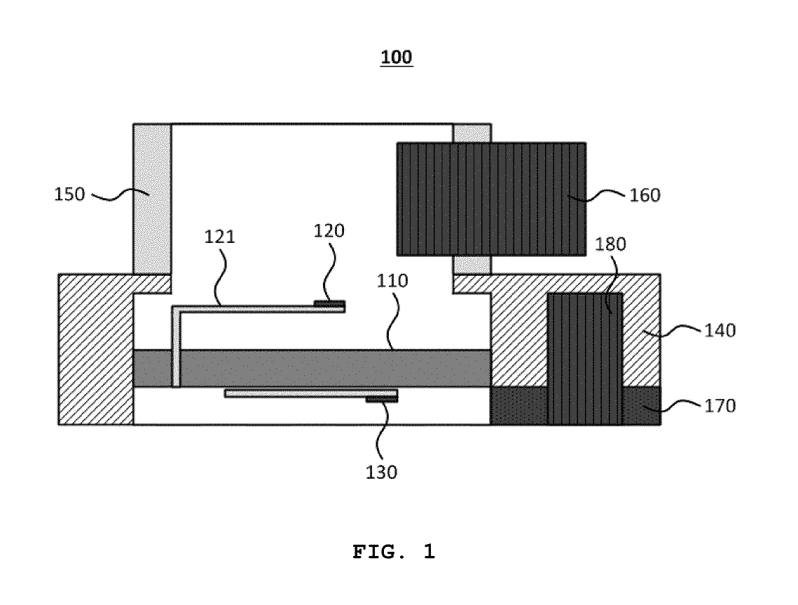

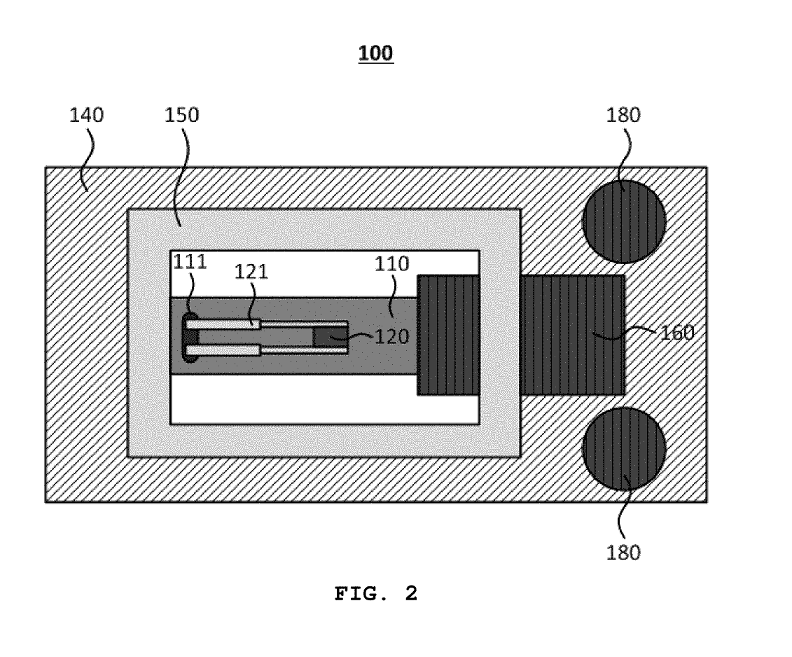

FIG. 1 is a sectional view illustrating a non-contact temperature sensing apparatus according to one embodiment of the present invention and FIG. 2 is a planar view illustrating the non-contact temperature sensing apparatus of FIG. 1. The non-contact temperature sensing apparatus (100) includes a substrate (110), a lead frame (121), an element (120) for sensing temperature, an element (130) for compensating temperature, and a case (140).

The substrate (110) includes a general PCB having wiring circuits and is connected to one end portion of the lead frame (121). The lead frame (121) is extended to an upper portion of the substrate (110). Preferably, a through hole 111 is formed at one side of the substrate (110). The lead frame (121) is vertically protruded from the through hole 111 and bended toward the upper portion of the substrate (110) to be extended. For example, the lead frame (121) is extended to the upper portion of the substrate (110) and bended in parallel with an upper surface of the substrate (110). Accordingly, it has a shape vertically or subvertically bended to the substrate (110) and consists of a pair.

The element (120) for sensing temperature is attached to the other end portion of the lead frame (121) and is mutually separated from the substrate (110) to be arranged. The element (130) for compensating temperature is attached to a lower surface of the substrate (110).

The element (120) for sensing temperature is separated from the substrate (110), so that it can decrease the influence of the substrate (110) caused by the thermal conductivity and decrease the thermal time constant by increasing the temperature-sensitive resolution. For example, since the element (120) for sensing temperature is not formed on the substrate (110) together with the element (130) for compensating temperature, the thermal response characteristic can be improved, thereby increasing the temperature-sensitive resolution. Also, since the element (120) for sensing temperature is separated from the substrate (110), it does not directly receive the heat of the substrate (110). Accordingly, it can accurately detect the temperature of the heat roller of the drum.

The element (120) for sensing temperature is separated from the surface of the substrate (110) at intervals of 0.1 mm to 5 mm and attached to the end portion of the lead frame (121) through a soldering or a resistance welding etc.

In the soldering method, the element for sensing temperature is inserted into the end portion of the lead frame and it is immersed in a bath within a few second to be soldered.

In the resistance welding method, welding electrodes separated at a predetermined interval are putted on one side of the surfaces of the lead frames 121 and it applies the current thereto to be heated, so that the electrode of the chip is welded to the lead frame (121). In the resistance welding method, the electrode formed on the chip and the lead frame (121) are melted in a very short time to be alloyed. At this time, after the welding of one side thereof, the other side thereof is welded in the same way.

In case of the resistance welding method, the large currents are flowed in a state of applying pressure thereto, so that the heat is obtained by the contact resistance generated from the contacting surface between the metals and the specific resistance of the metal. Accordingly, the metals are heated and welded and then, the bonding is made by the applied pressure. In the resistance welding method, it is possible to quickly weld the wide area for a short period.

The non-contact temperature sensing apparatus according to the present invention further includes a heat resistant polymer film (not shown) for protecting the element (120) for sensing temperature and the lead frame (121). The heat resistant polymer film may be made of a polyimide material or a Teflon material. For example, an encapsulation as heat resistant polymer film serve to protect the element (120) for sensing temperature or the heat resistant polymer film is attached to the parts of the upper and lower surfaces of the element (120) for sensing temperature and the lead frame (121) to protect the element (120) for sensing temperature.

Since the film made of the polyimide material has high thermal stability property and effective mechanical property, it can endure high temperature of about 400 degrees above zero or low temperature of 269 degrees below zero. Also, since the polymer film is thin and has a good flexibility, it can be used as a flexible PCB. For example, since the polymer film is thin and the flexibility thereof is superior, it is desirable to protect the lead frame 121 having a shape vertically or subvertically bended thereto.

In the element (120) for sensing temperature, the thermal time constant can be increased or decreased in response to the size or the thickness of the heat resistant polymer film. For example, in case of the element (120) for sensing temperature, where the size or the thickness of the heat resistant polymer film becomes larger, since the absorption of radiant heat is increased, the sensitivity thereof and the accuracy of the temperature are improved. However, since the thermal time constant is increased, it cannot quickly response to the temperature change. Here, in order to increase the thickness of the heat resistant polymer film, it can be used as multiple layers.

The element (130) for compensating temperature serves to compensate ambient temperature or background temperature of the element (120) for sensing temperature.

The substrate (110) includes wiring circuits for electrically connecting with the element (130) for compensating temperature and other wiring circuits for electrically connecting with the other end portion of the lead frame (121), which is connected to the element (120) for sensing temperature.

The element (130) for compensating temperature is electrically connected to the substrate (110) and can have a pair of lead frames for connecting the wiring circuits of the substrate (110). The element (130) for compensating temperature can be separated from and arranged in parallel with the lower surface of the substrate (110).

In the present invention, since the wiring circuits are formed by means of the general PCB and the element (130) for compensating temperature is attached to the substrate (110), the assembly work thereof is easy, the productivity thereof can be increased, and the repair and replacement thereof is easy. Also, since the element (120) for sensing temperature and the element (130) for compensating temperature are not formed on the same plane, it can be miniaturized.

The element (120) for sensing temperature and the element (130) for compensating temperature have the same thermo-sensitivity.

The case (140) serves to house the substrate (110), the element (120) for sensing temperature, and the element (130) for compensating temperature and accommodate the radiant heat flowed therein.

The case (140) includes an opening portion capable of flowing the radiant heat in the element (120) for sensing temperature at a front portion thereof. The element (130) for compensating temperature is attached to the lower surface of the substrate (110) and is directly not contacted with the radiant heat, and measures the ambient temperature or the background temperature of the element (120) for sensing temperature.

The non-contact temperature sensing apparatus (100) according to the present invention further can include a body tube portion (150) and a tuning portion (160).

The body tube portion (150) is formed on the upper portion of the case (140) and serves to provide an inflow path of the radiant heat. The body tube portion (150) is integrally formed like the opening portion of the case (140) so as to form the inflow path of the radiant heat.

The tuning portion (160) is formed at the body tube portion (150) and tuned through tightening and loosening in the manner of a screw or a sliding, so that the inflow value of the radiant heat flowed into the element (120) for sensing temperature can be controlled.

The tuning portion (160) serves to control the inflow value of the radiant heat, thereby controlling the output of the element (120) for sensing temperature.

The non-contact temperature sensing apparatus (100) according to the present invention further can include a lower cover (170) and a fixing member (180).

The lower cover (170) is formed on a floor surface of one side of the case (140) and includes a hole for inserting the fixing member (180) therein. The fixing member (180) is inserted into the hole of the lower cover (170) to be coupled. In the present invention, through the coupling of the lower cover (170) and the fixing member (180), the non-contact temperature sensing apparatus (100) is fixed.

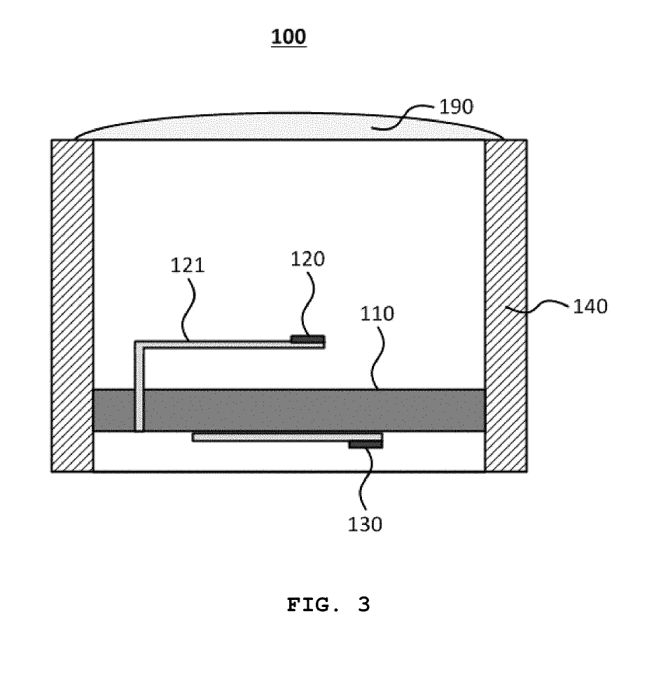

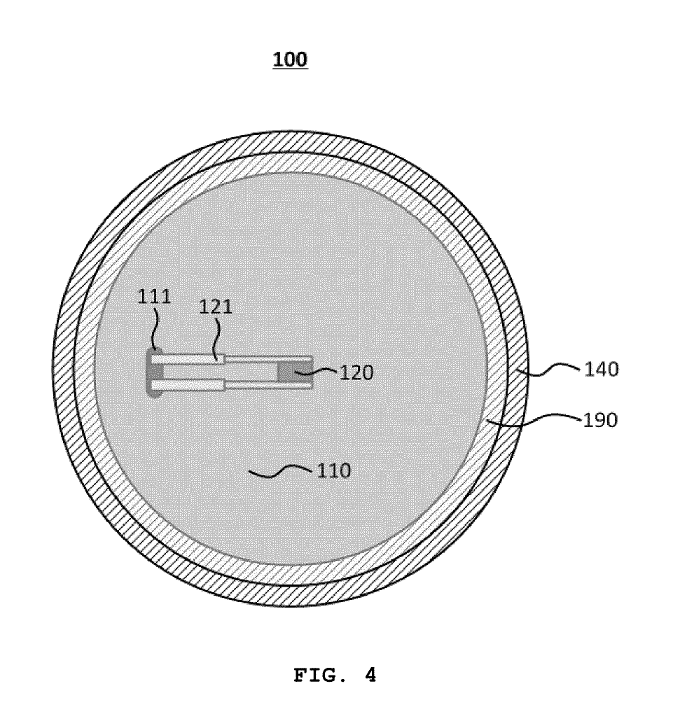

FIG. 3 is a sectional view illustrating a non-contact temperature sensing apparatus according to another embodiment of the present invention and FIG. 4 is a planar view illustrating the non-contact temperature sensing apparatus of FIG. 3.

Since FIG. 3 is another embodiment on the non-contact temperature sensing apparatus of FIG. 1, the explanations of the same elements of FIG. 1 are omitted here.

As shown, the non-contact temperature sensing apparatus (100) according to another embodiment of the present invention further includes a lens portion (190) for concentrating the radiant heat on the element (120) for sensing temperature formed on the upper portion of the case (140).

The case (140) serves to perform the function of the body tube portion (150) for providing the inflow path of the radiant heat.

The lens portion (190) serves to minutely adjust the focus of a lens, so that it focuses the radiant heat or the infrared ray toward the element (120) for sensing temperature, thereby quickly and accurately measuring the temperature by means of the element (120) for sensing temperature.

In the present invention, since the actual temperature detected by the element (120) for sensing temperature is different from the relative temperature detected by the lens portion (190), a temperature look-up table illustrating the relationship between the actual temperature and the relative temperature can be used. The temperature look-up table illustrates the relationship between the actual temperature and the relative temperature and the relative temperature is varied according to the distance with the heating element.

The lens portion (190) provides a function as a shield membrane for preventing the foreign substance from being flowed therein as well as the function for focusing the radiant heat thereon. Also, since the shield membrane is formed on the lens portion (190), the flow of air is blocked around the element (120) for sensing temperature and transmits only the influence of the radiant heat thereto, thereby providing the optimum environment in temperature measurement to the element (120) for sensing temperature.

As shown in FIG. 1 or FIG. 2, the lens portion (190) is formed on the upper portion of the body tube, so that it can collect the radiant heat and provide it to the element for sensing temperature.

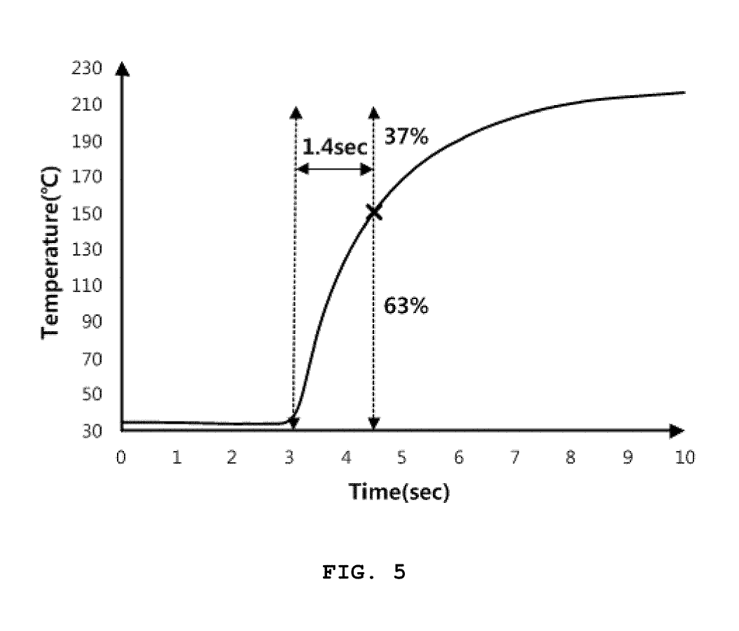

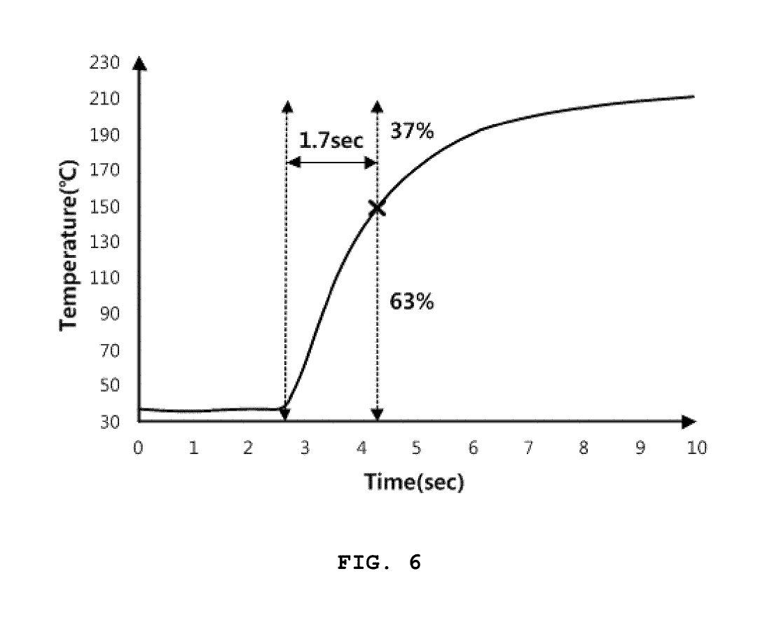

FIG. 5 is a graph illustrating a thermal response characteristic of a non-contact temperature sensing apparatus according to one embodiment of the present invention and FIG. 6 is a graph illustrating a thermal response characteristic of the conventional thermistor elements of a thin film type.

As shown, the thermal time constant of the conventional thin film type thermistor elements is 1.7 seconds. On the other hand, the thermal time constant of the non-contact temperature sensing apparatus according to one embodiment of the present invention is 1.4 seconds.

In other words, in the conventional thin film type thermistor elements, since the detecting element and the compensating element are mounted on one circuit board, the thermal response characteristic is deteriorated. However, since the element (120) for sensing temperature according to the present invention is separated from the substrate (110), it can decrease the influence of the radiant heat absorbed in the substrate (110) and increase the temperature-sensitive resolution, thereby improving thermal responsibility.

In the conventional thin film type thermistor elements, the voltage is 2.6923 V in a standby mode in that the temperature of the roller is 100° c. and the voltage is 2.5505 V in a state that it is heated to 200° c. corresponding to the print-out condition. On the contrary, in the element (120) for sensing temperature according to the present invention, the voltage is 2.5550 V in the standby mode in that the temperature of the roller is 100° c. and the voltage is 2.3089 V in a state that it is heated to 200° c. corresponding to the print-out condition.

Where the temperature detect and output resolution or the temperature detect resolution is high, it means that the output voltage difference between the compensation temperature and the detection temperature is large.

Since the output voltage difference of the conventional thin film type thermistor elements is 0.1418 V and the output voltage difference of the element (120) for sensing temperature according to the present invention is 0.2461 V, it can confirm that the element (120) for sensing temperature according to the present invention has a high temperature-sensitive resolution in comparison with the conventional thin film type thermistor elements.

While the present invention has been described with respect to the specific embodiments, it will be apparent to those skilled in the art that various changes and modifications may be made without departing from the spirit and scope of the invention as defined in the following claims.

What is claimed is:

1. A non-contact temperature sensing apparatus comprising:
a substrate having wiring circuits and connected to one end portion of a lead frame;
the lead frame extended to an upper portion of the substrate;
an element for sensing temperature attached to the other end portion of the lead frame;
an element for compensating temperature attached to a lower surface of the substrate; and
a case for housing the substrate, the element for sensing temperature, and the element for compensating temperature and accommodating a radiant heat flowed therein,
wherein the element for sensing temperature is separated from the substrate, whereby increasing a thermal responsibility.

2. The non-contact temperature sensing apparatus as claimed in claim 1, wherein the lead frame is extended to the upper portion of the substrate and bended in parallel with an upper surface of the substrate.

3. The non-contact temperature sensing apparatus as claimed in claim 1, wherein the element for sensing temperature is separated from a surface of the substrate at intervals of 0.1 mm to 5 mm.

4. The non-contact temperature sensing apparatus as claimed in claim 1, wherein the element for sensing temperature and the element for compensating temperature have the same thermo-sensitivity.

5. The non-contact temperature sensing apparatus as claimed in claim 1, wherein the element for sensing temperature is attached to an end portion of the lead frame through a soldering or a resistance welding.

6. The non-contact temperature sensing apparatus as claimed in claim 1, further comprising a heat resistant polymer film for protecting the element for sensing temperature and the lead frame.

7. The non-contact temperature sensing apparatus as claimed in claim 6, wherein the heat resistant polymer film is made of a polyimide material.

8. The non-contact temperature sensing apparatus as claimed in claim 1, further comprising:
a body tube portion formed on the upper portion of the case and providing an inflow path of a radiant heat; and
a tuning portion formed at the body tube portion and tuned through tightening and loosening in the manner of a screw or a sliding so as to control an inflow value of the radiant heat flowed into the element for sensing temperature.

9. The non-contact temperature sensing apparatus as claimed in claim 1, further comprising a lens portion for concentrating a radiant heat on the element for sensing temperature formed on the upper portion of the case.
